(19) United States
(12) Patent Application Publication
(10) Pub. No.: US 2008/0101838 A1
(43) Pub. Date: May 1, 2008

(54) RIBBON MODULE STRUCTURE OF LABEL PRINTER

(76) Inventors: Feng-Yi Tai, Taipei Hsien (TW); Jung-Chin Chang, Taipei Hsien (TW)

Correspondence Address: G. LINK CO., LTD., 3550 BELL ROAD, MINOOKA, IL, 60447, US

(21) Appl. No.: 11/968,165

(22) Filed: Jan. 1, 2008

Related U.S. Application Data
(63) Continuation-in-part of application No. 11/187,142, filed on Jul. 22, 2005, now abandoned.

(51) Int. Cl. B41J 33/16

(52) U.S. Cl. 400/236

(57) ABSTRACT

A ribbon module structure for a label printer includes a fixed frame an input shaft and a retrieving shaft. An end of the input shaft is provided with a turning mechanism, and the retrieving shaft is attached to a driving mechanism. The turning mechanism further includes a connecting member and a control member. The control member is capable of being actuated to swing an angular displacement and the connecting member is capable of rotating clockwise and counterclockwise corresponding to movement of the control member for two types of thermally-induced ribbons being retrievable with the label printer.

The application is a continuation in part of application Ser. No. 11/187,142

### BACKGROUND OF THE INVENTION

1. Field of the Invention

The present invention relates to a ribbon module structure of label printer, and more particularly to a ribbon module structure capable of retrieving ribbons with different transfer printing sides.

2. Description of the Prior Art

Currently, the label printer provides a main body and an axle. A label roll fits with the axle. The main body is composed of a ribbon frame and a printing frame. The printing frame has two rollers, and one of the rollers is driven by a driving mechanism. Thermally-induced ribbons are disposed on the rollers. Therefore, the label and the thermally-induced ribbons are synchronously actuated by the main body, and characters or figures are transferred to the label from the thermally-induced ribbons by a print head. However, the conventional thermally-induced ribbons are classified into inner-winding and outer-winding types according to the thermally-induced material being coated on which side of the ribbon. That limits the performance of the conventional label printer. Hence, a label printer, which is suitable for both the inner-winding and outer-winding types of thermally-induced ribbons, has been developed. Nevertheless, the label printer suitable for both the inner-winding and outer-winding types of thermally-induced ribbons has to be switched over to adapt to the specific type thermally-induced ribbon manually. Further, the thermally-induced ribbons have a limited retrievable angular displacement. Therefore, it is inconvenient for the user to check the printed content on the label.

### SUMMARY OF THE INVENTION

In view of the problems of related conventional arts a main objective of the present invention is to provide a ribbon module structure for a label printer, which provides a turning mechanism at an end of the input shaft thereof adaptable for both the inner-winding type and the outer-winding type of thermally-induced ribbons.

Accordingly, a ribbon module structure for a label printer according to the present invention comprises a fixed frame, an input shaft and a retrieving shaft, wherein a turning mechanism is installed at one end of the input shaft and a driving mechanism is attached to the retrieving shaft. Further, the turning mechanism provides a connecting member and a control member and the control member is capable of pivotally moving an angular displacement rightward and leftward respectively to allow the input shaft rotating clockwise and counterclockwise with the connecting member corresponding to the pivotal movements of the control member such that two retrieving modes can be offered for retrieving the inner-winding and the outer-winding types thermally-induced ribbons.

### BRIEF DESCRIPTION OF THE DRAWINGS

FIG. 1 is a disassembled perspective view of a ribbon module structure for a label printer according to the present invention.

FIG. 2 is an assembled perspective view of the ribbon module shown in FIG. 1.

FIGS. 3A and 3B are diagrams illustrating the control member of a turning mechanism pivotally moving an angular displacement and allowing the connecting member of the turning mechanism rotating clockwise.

FIGS. 4A and 4B are diagrams illustrating the control member of a turning mechanism pivotally moving another angular displacement and allowing the connecting member of the turning mechanism rotating counterclockwise.

### DESCRIPTION OF THE PREFERRED EMBODIMENT

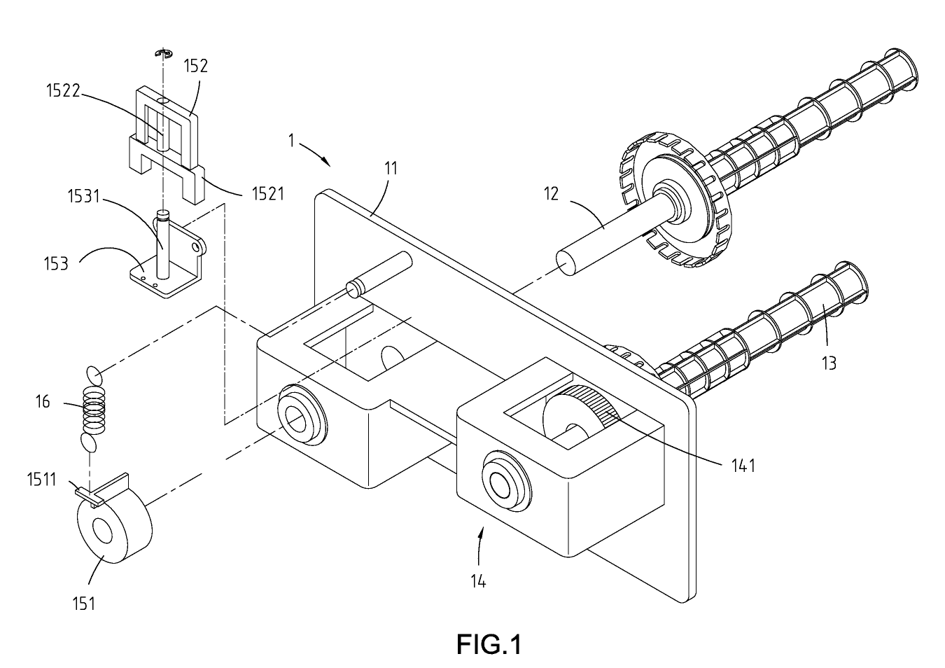

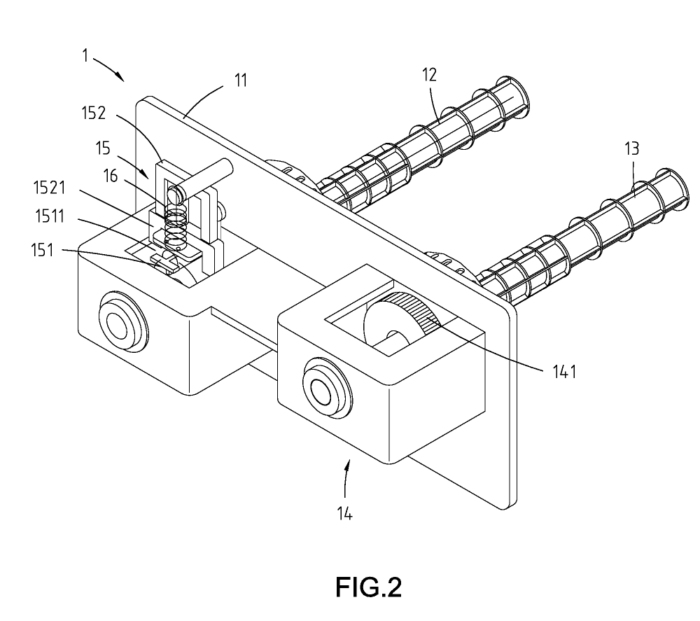

Referring to FIGS. 1 and 2, a ribbon module 1 of the present invention, which is installed in a label printer comprises a fixed frame 11, an input shaft 12 and a retrieving shaft 13. The input shaft 12 and the retrieving shaft 13 are attached to the fixed frame 11. The retrieving shaft 13 is driven by a driving mechanism 14, which has a driving gear 141. A turning mechanism 15 is joined to the input shaft 12.

The turning mechanism 15 further comprises a roller-shaped connecting member 151 and a double-inverted-U-shaped control member 152. The connecting member 151 is attached to an end of the input shaft 12 with a T-shaped stop arm 1511 disposed on the circumferential side of the connecting member 151. The stop arm 1511 forms a flexible connection with the fixed frame 11 by means of an end of an elastic member 16 engaging the stop arm 1511 and another end of the stop arm 1511 engaging with a locating rod extending from the fixed frame 11. An L-shaped bracket 153 provides a pivot 1531 extending from the bottom of the bracket 153 to pass through the hollow shaft 1522 and movably engaging with the control member 152 with a retaining ring. The bracket 153 is attached to the fixed frame 11 such that the control member 152 is pivotally disposed on top of the connecting member 151. Furthermore, the control member 152 has two blocking sides 1521 are provided at the lower portion thereof. When the control member 152 pivotally moves an angular displacement leftward or rightward, one of the blocking sides 1521 can approach the fixed frame 11 to block the space between the control member 152 and the fixed frame 11.

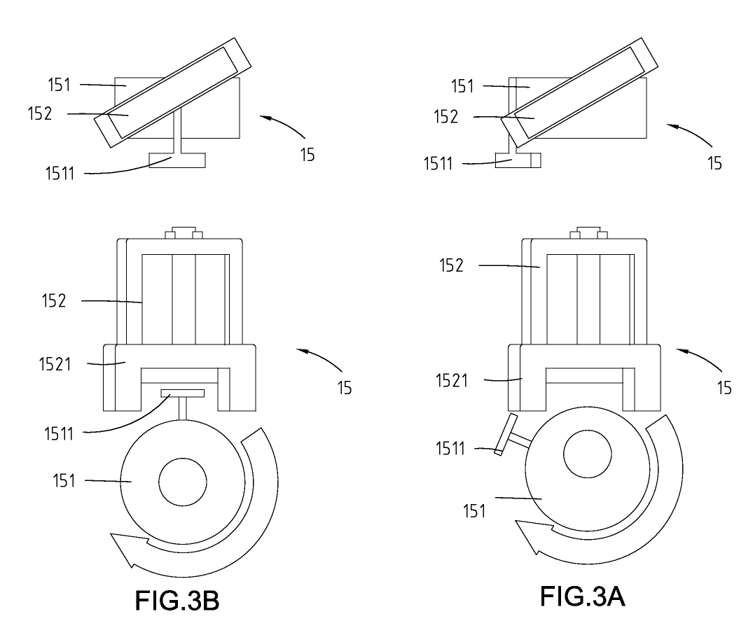

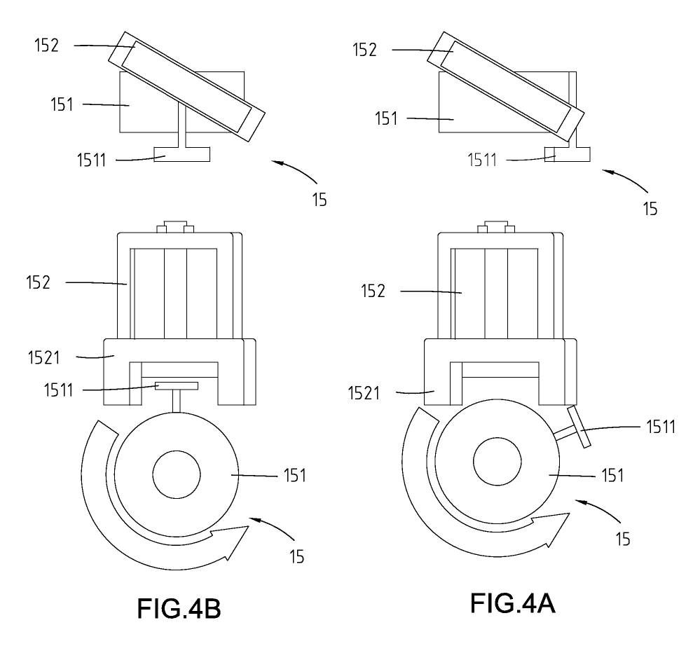

In practice, the ribbon module 1 is one of parts of a label printer and other parts are conventional structures and not belonged to the scope of the present invention. Hence, no details are recited for the remainder parts of the label printer. As the foregoing, the thermally induced ribbons are classified into the inner type and the outer type according to the thermally induced material being coated on the inner side or the outer side of the respective ribbon. That is, the input shaft 12 has to rotate with the thermally induced ribbon either clockwise or counterclockwise based on which side of the ribbon coated with the thermally induced material. It can be seen in the FIGS. 3A and 3B that the control member 152 of the turning mechanism 15 is pivotally moved to swing an angular displacement in advance for interfering with the stop arm 1511 with one of the blocking sides 1521 of the control member 152. As a result, the connecting member 151, which is attached to the input shaft 12, can rotate clockwise only to retrieve one type of the thermally induced ribbon. Similarly, FIGS. 4A and 4B shows that the control member 152 is pivotally moved to another angular displacement opposite to that shown in FIGS. 3A and 3B in advance to interfere with the stop arm 1511 such that the connecting member 151 can rotate counterclockwise only for retrieving another type of thermally induced ribbon.

Although specific embodiments have been illustrated and described, it will be obvious to those skilled in the art that various modifications may be made without departing from what is intended to be limited solely by the appended claims.

What is claimed is:

1. A ribbon module structure for a label printer comprising:
a fixed frame;
an input shaft being attached to said fixed frame; and
a retrieving shaft being attached to said fixed frame next to said input shaft and being driven with a driving mechanism;
wherein an end of said input shaft is provided with a turning mechanism, and said turning mechanism further comprises:
a roller-shaped connecting member fitting with said end and providing a T-shaped stop arm at the circumferential side thereof;
a double inverted-U-shaped control member being disposed on top of said connecting member, and having a hollow shaft at the central position of an upper inverted-U-shaped portion thereof and two lateral blocking sides of a lower inverted-U-shaped portion thereof; and
a L-shaped bracket providing a pivot to pass through said hollow shaft and pivotally engage with said control member and being attached to said fixed frame such that said control member is capable of being actuated to swing an angular displacement with respect to said pivot and said connecting member is capable of rotating clockwise and counterclockwise corresponding to said control member.

2. The ribbon module structure according to claim 1, wherein said connecting member is resisted to rotate a direction at which said control member swings to interfere said stop arm with one of said lateral blocking sides thereof.

3. The ribbon module structure according to claim 1, wherein an elastic member is provided to engage with said stop arm with an end thereof and to engage with said fixed frame with another end thereof.

4. The ribbon module structure according to claim 1, wherein said driving mechanism provides a driving gear.
